(19) United States
(12) Patent Application Publication
(10) Pub. No.: US 2020/0048804 A1
(43) Pub. Date: Feb. 13, 2020

(54) PROCESS FOR TRANSFORMING CARBON FIBRES, SYNTHETIC FIBRES AND VEGETABLE FIBRES INTO NON-WOVEN FABRIC

(71) Applicant: INNOVATIVE RECYCLING S.A., Lugano (CH)

(72) Inventor: Paolo Ferrari, Milano (IT)

(21) Appl. No.: 16/495,911

(22) PCT Filed: Mar. 21, 2018
(86) PCT No.: PCT/IB2018/051891

§ 371 Date: Sep. 20, 2019

(30) Foreign Application Priority Data
Mar. 21, 2017 (CH) 00354/17

(51) Int. Cl. D04H 1/4274; D04H 1/4242; D04H 1/70; A61C 13/02

(52) U.S. Cl. CPC D04H 1/4274; A61C 13/02; D04H 1/70; D04H 1/4242

(57) ABSTRACT

Process for transforming synthetic and vegetable fibres into a non-woven fabric of the type which provides the following sequence of processing steps: flock opening step, during which fibrous materials of different shapes and sizes are transformed into fibre flocks of different lengths; drawing and treatment step of the material selected in the previous step; cutting and trimming step: once the drawing and treatment step of the material has been completed, the non-woven fabric is subject to longitudinal cutting and trimming, to make a series of rolls, usually two or three, for final use, characterised in that, after the opening step, the flocks are transferred to a condenser, where the long-fibre flocks are separated from the short-fibre flocks, by means of a perforated mesh screen.

### TECHNICAL FIELD

The present invention patent relates to a process for transforming carbon fibres into a non-woven fabric that can be applied to all types of synthetic and vegetable fibres for subsequent use in the production of thermosetting, thermoplastic and concrete matrix composites, and use of the composites thus produced for the production of synthetic items for the most diverse industrial sectors.

### KNOWN ART

The production techniques of non-woven fabric are known, which are substantially adapted to obtain a product having a macroscopically similar appearance to a fabric, but made with techniques different from warp. These products are made up of natural or synthetic fibres arranged in layers, or crossed, held together mechanically by needles, or adhesives, or with thermal processes.

Since these processes have substantial production costs and the obtained materials are often particularly resistant to wear, solutions have been sought over time for the regeneration and recycling of carbon fibres, in order to reduce the production costs and maintain a keen attention to environmental issues.

It has also been recognized that—as in the case of conventional fabrics—in the processing steps subsequent to the manufacturing process, the fabrics of interest are cut according to specific use needs, giving rise to “scrap pieces”, or waste, which must be subject to disposal.

The need therefore arises to find processes for treating non-woven fabric fibres so that they can be re-used, in order to reduce production and disposal costs and to limit the related environmental problems.

Therefore, methods for the regeneration and recycling of carbon fibres have been developed, with the aim of reducing the costs of production on one hand and limiting the environmental impact and disposal and reclamation operations of unused material on the other hand.

Typically, such regeneration processes provide for recovering carbon fibres by subjecting them to multi-step pyrolysis and—once the original structure has been broken down—subjecting them to a new treatment by contact with a siloxane binder and to shaping to form discrete particles for a subsequent new preparation treatment of a non-woven fabric.

At the same time, it was found that, over the years, great attention has been paid to the production of carbon fibre and resin industrial items, substantially replacing items normally made of various materials with identical products made of carbon fibre and resin.

These products are made of virgin carbon fibres in the form of fabrics, having a defined weft and warp, and of biological thermosetting resins.

### Problem and Solution

However, these techniques have some disadvantages relating to both problems. In particular, it has been found that the making of the obtained product is apparently unattractive for use in sectors which require a pleasing look and/or feel, or require a limited thickness.

Moreover, in certain processes, the need is felt to couple together several layers of carbon fibre of the same nature, or of different nature. In particular, there is a need to associate a surface layer of virgin fibre with one or more layers of recycled fibre in order to allow pleasing aesthetic effects for the user, which allow to suppose the same appearance of a virgin fibre item.

The known techniques currently in use generate a non-woven fabric having an excessively high thickness, which is often difficult to apply because its placement in the impregnation mould is complex; consequently, a finished product is obtained which does not have the desired physical and aesthetic properties.

Moreover, the items are made by stratifying fabrics made of weft and warp in virgin carbon fibre, with the obvious disadvantage that in relatively short times a separation by delamination of the various layers making up the product occurs, thus requiring rapid replacement, with the consequent inconvenience for users.

Therefore, the need to solve these disadvantages is felt, so as to meet the needs of producers and consumers.

Secondly, it is necessary to reduce the costs for carrying out the process, so as to make it totally competitive with the production of raw material.

Said objects are obtained through a process for the transformation of carbon fibres into non-woven fabric having the features described in the main claim and for the realization of a specialized item for the production of finished products as defined in claims 19) to 21). Other preferred features are reported in the secondary claims that best define the scope of the solution adopted herein.

### BRIEF DESCRIPTION OF THE DRAWINGS

The process according to the invention is now described in detail with reference to the attached figures.

FIG. 1 is a view for illustrating a flowchart of the non-woven fabric treatment process according to the invention;

FIG. 2 is a front view of a base disc for circular shaped products;

FIG. 3 is the front view of a base tile for flat products;

FIG. 4 is the front view of an ingot for highly three-dimensional products.

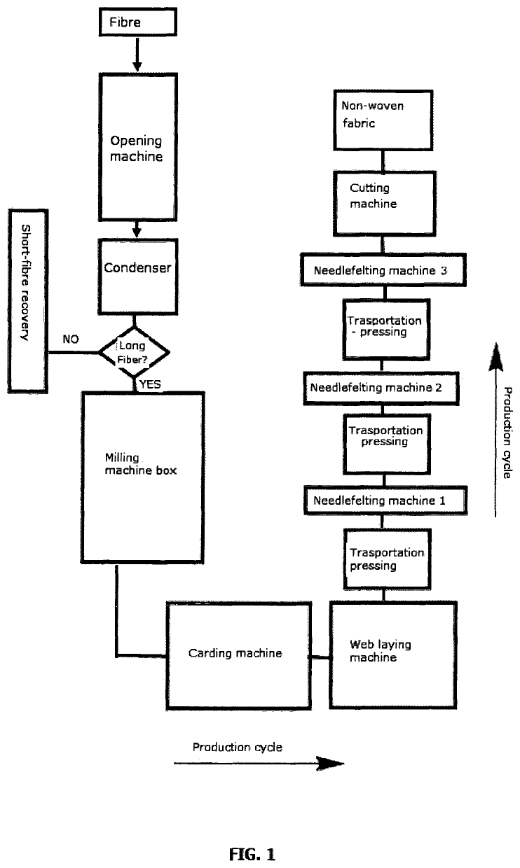

### DETAILED DESCRIPTION OF A PREFERRED EMBODIMENT

As in the prior art, the process for making a non-woven fabric according to the invention comprises three main steps, which will then be described in detail, step by step, in order to make the process clearer.
Opening step, during which fibrous materials of different shapes and sizes are opened, or defibred, by means of opening machines that transform incoming materials into fibre flocks of different lengths;
Drawing and treatment step of the material coming from the previous step to build a new non-woven fabric.
Cutting and trimming step: once the drawing and treatment step of the material has been completed, the non-woven fabric is subjected to longitudinal cutting and trimming, to make a series of rolls, usually two or three, for final use.

Each single step of the passage will now be defined with greater precision, making specific reference to a preferred embodiment.

The opening step is relatively simple, as anticipated above, and it is envisaged to physically act on the fibre material to be treated, so as to defibre the original compound and obtain flocks of fibrous material.

Once ready, the flocks are transferred by mechanical or pneumatic conveying means into a condenser which acts as a separator of flocks composed of long fibres from flocks composed of short fibres.

There, they are then treated with a perforated mesh screen for the separation of the long-fibre flocks from the short-fibre flocks, or the single short fibres, since the long fibres allow to increase the mechanical capacity of the finished product, and to make the binding between the fibres stronger during processing. Therefore, since the short fibres are not useful for obtaining the desired quality product, they are separated and their recycling in materials of ground carbon fibre is arranged.

The long-fibre flocks are instead taken to a collection vessel—commonly known as a “milling machine box”—for the subsequent drawing and treatment step.

Before selecting the fibres, or after that, it is advisable that the selected flocks are humidified, according to the needs of the moment, linked above all to the material being worked and the properties that will be obtained at the end of the process.

This process allows to increase the specific weight of the flocks mass, also in view of the particular lightness and elasticity properties of some fibres that could be treated in this process, such as carbon fibres. Moistening takes place via a nebulization system installed along the part of the system included between the devices for fibre opening up to the web laying machine. As can be easily understood, the nebulization system undergoes different programming depending on the specific material being used.

Once the screening (and possibly the moistening) has been completed, the process involves the step of drawing the flocks collected in the milling machine box and their subsequent carding for the formation of a fibre web, in which the flocks are transferred from the milling machine box to the carding machine, for their combing and the constitution of a homogeneous web.

The carding process is particularly important for obtaining a non-woven fabric having the desired physical and aesthetic properties. Therefore, it was necessary to substantially change this step compared to what has been commonly realized up to now.

In particular, it has been found that the carding machine provided a number of working rollers comprised between a minimum of two and a maximum of six, to obtain a web having the desired properties, and in particular a thickness comprised between 0.1 and 0.5 mm.

Furthermore, it is advisable to install a so-called brush roller which keeps the drum clean from the fibre residues generated by the carding process, avoiding flooding the machine.

The process also provides for the proper adjustment of the speed ratios of each group of working rollers, so as to obtain the correct feed rate so that a homogeneous web, suitable to pass to the further process steps, can be obtained from the product being treated.

The so-structured carding step allows to proceed with a leaner fibre processing, thus reducing time and costs on the one hand, and the risk that the fibre is subjected to excessive stress on the other hand.

Once the carding has been completed, the obtained web is brought to the web laying, that is the overlapping step of several webs—in the number required to obtain the desired weight—from the carding output by means of a belt-type web laying machine.

At the end of this step, relatively simple and completely known to a person skilled in the art, the mass composed of the webs is particularly thick, due to the presence of air between the various superimposed webs and between the fibres that make up the individual webs.

In order to reduce the volume, and therefore to obtain a non-woven fabric with high mechanical and physical properties, and very thin at the same time, a few millimetres thick, the mass is first subjected to a transport and pressing step by means of superimposed belts or rollers. Said superimposed belts or rollers initially have a convergent wedge conformation to take a horizontal configuration so that they are arranged parallel to one another.

This step reduces the amount of air present in the mass, so as to increase the performance of the subsequent processing steps, and consequently the quality of the finished product.

The web thus pressed is then fed into needlefelting machines, provided with plates with needles, so that when the layered mass passes, the needles penetrate it deeply and bind the fibres together, thus transforming the web mass into a homogeneous structure. Therefore, the pressing makes the process of binding the fibres more efficient, since the air gap that is originally formed between the various fibres is reduced.

In the case in question, a series of three needlefelting machines are provided, to facilitate the processing operations. The needlefelting process can take place in a variety of ways, all equally performing: it can be assumed that the needlefelting takes place first from the top by the first needlefelting machine, then from the bottom by the second needlefelting machine and finally from the top by the third needlefelting machine.

Alternatively, it is also possible to envisage operating first “from the bottom” by the first needlefelting machine, then “from the top” by the second needlefelting machine and finally “from the bottom” from by third needlefelting machine.

Finally, it is possible to predict that the procedure is first “from the top and from the bottom simultaneously” by the first needlefelting machine and then “from the top and from the bottom simultaneously” by the second needlefelting machine. In this case, a third passage “from the top and from the bottom simultaneously” from the third needlefelting machine is also required.

In order for the process to have the desired results, each passage of the web mass through the needlefelting machine should be preceded by a respective transport and pressing step.

The processing envisages that the depth of insertion of the needle into the web mass varies according to the desired thickness for the non-woven fabric, according to known processing techniques.

The fibre thus formed by the process described above can undergo particular processings which allow to couple together several layers of carbon fibre of the same nature, or of different nature. In particular, it is possible to associate a surface layer of virgin fibre with one or more layers of recycled fibre in order to allow pleasing aesthetic effects for the user, allowing to suppose the same appearance of a virgin fibre item. For this further step, a high temperature processing with calenders is envisaged.

Once the product has been completed, it is possible to proceed with the cutting step, which takes place by means of a cutting machine with disc blades: the disc blades exert pressure, and therefore perform cutting, on a transverse roller.

The resulting product follows the usual packaging and storage procedures used for the original non-woven fabrics.

Experimental tests on the product obtained from the process described herein could demonstrate unpredictable physical properties of mechanical strength.

As can be seen from Table 1 below, in fact, the results obtained are inferred by comparing the product obtained from the process according to the invention (TNT INV: non-woven fabric of the invention) with a conventional product obtained from a virgin fabric manufacturing process (T V).

TABLE 1

| | | |
|---|---|---|
| T V | TNT INV | Difference |

| Flexural strength (MPa) | 634.25 | | 561.34 | | −11.5% |
|---|---|---|---|---|---|
| Flexural modulus (MPa) | 35.29 | | 43.32 | | +18.5% |
| (cut) | 53.91 | | 52.90 | | −0.02% |
| Energy absorption 1 J | 0.37 | J | 0.14 | J | −62% |
| Energy absorption 10 J | 6.0 | J | 6.0 | J | 0 |
| Energy absorption 25 J | 21.8 | J | 24 | J | +9.2 J |

Tables 2 to 4 show some of the main physical properties which define respectively the tensile strength, flexural strength and impact resistance values of a recycled non-woven fabric according to the process described above.

TABLE 2

| | NON-WOVEN FABRIC |
|---|---|
| MAXIMUM LOAD (MPa) | 300 |
| ELASTIC MODULUS (GPa) | 35.2 |

TABLE 3

| | NON-WOVEN FABRIC |
|---|---|
| MAX STRESS | 408 |
| DEFORMATION TO Sm % | 1.6 |
| ELASTIC MODULUS (GPa) | 28.5 |

TABLE 4

| | ABSORBED ENERGY (J) |
|---|---|
| IMPACT ENERGY (J) 14.47 | 2.1 |
| IMPACT HEIGHT (mm) 135 | |

It is well understood that the results are surprising and interesting, since it is evident that in some cases the performances are better than in the case of a virgin fibre, showing that the use of non-woven fabric produced according to the process described herein makes it possible to increase the resistance to rupture at high temperatures.

Excellent energy absorption properties have also been highlighted, following impact tests, as well as flexural and tensile strength tests.

The tests have also been able to demonstrate that the innovative pressing fraction allows to obtain particularly appreciable ratios between the weight and the maximum and minimum thicknesses of the non-woven fabric obtained at the end of processing, as can be seen from the attached Table 5.

TABLE 5
List of thicknesses per weight

| | | |
|---|---|---|
| Weight | Min thickness | Max thickness |

| | | | | | |
|---|---|---|---|---|---|
| 70 | gsm | 0.35 | mm | 0.70 | mm |
| 100 | gsm | 0.5 | mm | 2 | mm |
| 200 | gsm | 1 | mm | 4 | mm |
| 300 | gsm | 1.5 | mm | 6 | mm |
| 400 | gsm | 2 | mm | 8 | mm |
| 500 | gsm | 2.5 | mm | 10 | mm |
| 600 | gsm | 3 | mm | 12 | mm |
| 700 | gsm | 3.5 | mm | 14 | mm |
| 800 | gsm | 4 | mm | 16 | mm |
| 900 | gsm | 4.5 | mm | 18 | mm |
| 1000 | gsm | 5 | mm | 20 | mm |

Reference is now intended to be made to the specific variants of the process now described that allow to obtain specific items, which have particularly noteworthy innovative properties.

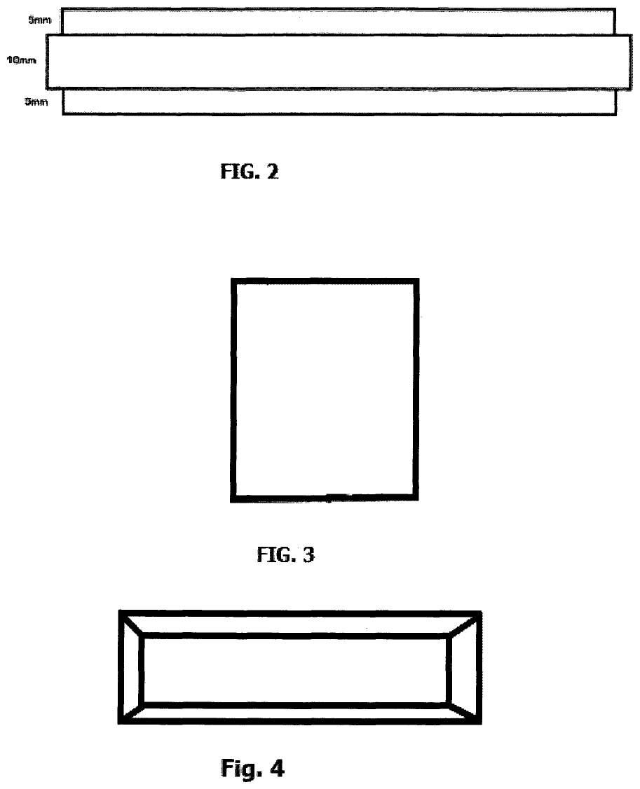

In particular, the solution shown in FIG. 2 is aimed at representing a basic disc for circular shaped items, for example dental prostheses. The non-woven carbon fibre fabric recycled according to the process described above is pre-cut by means of circular section die cutters in two different diameters. In this way, the section of the disc with a smaller diameter allows the coupling to the blocking frame of the milling machine disc. This pre-die-cutting process is fully innovative, since it cannot be used with virgin carbon fibre fabrics because they are made of carbon fibre threads that create a certain resistance to the die cutter that does not allow them to be cut.

The sections of non-woven fabric discs, which will have two different diameters, can be used in two different ways, that is as monolithic discs obtained from a single layer of non-woven fabric having a weight useful to determine the desired thickness of the respective section of the disc, or as discs of non-woven fabric obtained from a series of non-woven fabric layers associated by coupling so as to determine the desired thickness of the respective section of the disc.

Understandably, the resulting total thicknesses of the discs are different, ranging from 12 mm to 50 mm.

In any case, for all the discs with different thicknesses, the central section, which has a thickness of 10 mm, must be respected in order to be able to lock the disc in the blocking housing of the milling machine. Therefore, for example, if a disc must have the resulting total thickness of 15 mm, having the central section thickness of 10 mm, the upper and lower sections shall be specular to each other and 2.5 mm each respectively.

Depending on the specific reference diameter, the pre-die-cut non-woven fabric disc sections will respectively be inserted into their guided mould section.

Finally, the standard RTM lamination process will follow, i.e. closing the mould, creating a vacuum at 1 bar, injecting the resin or the bio-resin, the operating pressure varying, depending on the resin or the bio-resin, from a minimum of 10 bars to a maximum of 80 bars.

Once the resin is injected, the item is heated with a temperature that can vary from a minimum of 30° to a maximum of 150° for a time that can vary from a minimum of 1 minute to a maximum of 40 minutes. This treatment is necessary to allow the resin to react and reticulate.

Finally, once the formed pieces have been extracted from the mould, burrs are eliminated, and surfaces are polished and packaged, so as to obtain a matrix ready for moulding to constitutes an item, such as a dental prosthesis.

In the second variation, shown in FIG. 3, the process is carried out by realizing a tile obtained by pre-cutting the previously described recycled carbon fibre non-woven fabric, in order to obtain the physical properties required for the predetermined purposes. This operation takes place through die cutters with variable section depending on the needs, e.g. a square or rectangular shape, in the required sizes.

The sections of the squares or rectangles of non-woven fabric, which have measurements according to the need, may have the shape of monolithic squares or rectangles obtained from a single layer of non-woven fabric in a weight that helps to determine the desired thickness of the respective section of the tile, or may have the shape of squares or rectangles of non-woven fabric obtained from a layer of non-woven fabric at a certain useful weight and which will be coupled to determine the desired thickness of the respective tile section.

In order to obtain the correct shape, a steel mould will be made for RTM use which will have the specific shape of the tile.

Similarly to the solution described in FIG. 3, it is possible to make an ingot—which has the aspect shown in FIG. 4—having substantially the same construction characteristics and physical properties of tolerance and resistance. The choice of a different form has merely structural reasons, i.e. the need to obtain different thicknesses. As in the previous embodiment, the formed ingot is subject to milling by means of special machinery.

The pre-die-cut sections of non-woven fabric tile or ingot will be inserted respectively in their guided mould section, having specific measures.

For both solutions, after the pre-die-cutting the standard RTM lamination process will be following, i.e. closing the mould, creating a vacuum at 1 bar, injecting the resin or the bio-resin with pressure bars, depending on the resin or the bio-resin, which can vary from a minimum of 10 bars to a maximum of 80 bars.

Once the resin has been injected, the temperature will be raised which, depending on the resin or bio-resin, can vary from a minimum of 30° to a maximum of 150° and for a time which, depending on the resin or bio-resin, can vary from a minimum of 1 minute to a maximum of 40 minutes, which allow the resin or bio-resin to react and reticulate.

Finally, once the pieces formed by the mould have been extracted, burrs will be eliminated, and pieces will be polished and sprayed with a suitable primer or resin to make the resulting product compatible with animal and human bone tissues, or they will be immersed in a bath with an appropriate primer or resin to make the resulting product compatible with animal and human tissues, dried in the oven, and finally packed.

Such forms are used, for example, to produce resin bones—respectively flat or long—for bone implants, and therefore, following this solution, reference will be made to promote understanding of the process.

Once the desired shape of the final bone has been created by milling, removal of the milling slag will be performed, followed by polishing and spraying with a suitable primer or resin to make the bone compatible with human tissues, or immersing it in a bath with a suitable primer or resin to make the bone compatible with human tissues, oven drying, and finally packing.

With reference to drying, before use, depending on the raw materials, it will be necessary to check if the primer or the resin only need drying, or if the primer or the resin being made of catalyst will have to react and reticulate in the oven to create a protective web.

It is possible to obtain the same items using a variation of the process based on the practice of impregnation and realization of the above-described items. The non-woven fabric, in the desired weight and/or in the weight determined by the desired final item, is impregnated with the chosen resin or bio-resin, always on the basis of the desired final product and for the specific application. The percentages of impregnation can vary by weight with reference to the non-woven fabric weight, from 30% up to 70%. In order to reinforce the structure of the non-woven fabric now produced, the application of several longitudinal seams, parallel to each other, for the entire length of the piece of non-woven fabric, is envisaged. Preferably, the distance between two seams can vary from 1 mm to 100 mm.

With this alternative solution, it has been possible to guarantee that the non-woven fabric according to the invention has a greater resistance to stress and pulling, against which the random fibre arrangement conventional impregnation practices on the non-woven fabric appeared to be lacking, since the non-woven fabric stretched or broke.

Once the non-woven fabric has been impregnated with resin or bio-resin, the drawing of one or more layers thereof will be performed inside the mould and counter mould, both made of steel, which together create the shape of a parallelepiped, having a volume that can vary between 1 mm³ and 1 m³, respectively giving shape to slabs, tiles and ingots, ready for use in various industrial sectors.

The manufacturing process involves the insertion of the pre-impregnated non-woven fabric in a hot mould, with a temperature ranging from a minimum of 30° C. to a maximum of 240° C., depending on the resin or bio-resin used, and the subsequent closing and pressing of the counter mould on the mould, under conventional operating conditions, to allow the resin to react and reticulate. Once the piece has been created, it will be extracted from the mould and passed to the milling once it has reached the optimal processing temperature.

The milling system dedicated to the processing of the disc-shaped elements, and in particular of dental prostheses, involves processing with “multiple milling machines”, i.e. having three milling machines for each disc, two opposed ones and a single one, each milling machine having a specific diameter, which can theoretically vary from a minimum of 1 mm to a maximum of 1 m and a specific width of the working toothing, which can theoretically vary from a minimum of 0.01 mm to a maximum of 1 m.

Since the disc has—as previously described—a central lateral groove with a standard width of 10 mm, useful to allow the specific milling machine for dental prostheses to hook the disc into the block housing, a milling machine will be built which is in turn equipped with a hooking system on the worktop, allowing all the milling machines to work at the same precise point. The working order is the first pair of opposed milling machines, followed by the second and single extraction milling machine, without losing the exact centring.

The first two milling machines operate opposed to each other, one working from the top and the other working from the bottom, the smaller diameter corresponding to the smaller diameter of the disc, and they realize a partial plate penetration, up to the useful point, so as to obtain the 10 mm side groove of the disc.

The second milling machine, on the other hand, works only from the top, having a larger diameter, corresponding to the larger diameter of the desired disc, which includes the 10 mm side groove of the disc, and completely penetrates the plate, thus dropping the disc on the rubber collection belt, which is located inside the milling machinery and, being made of rubber, will cushion the fall and convey all the discs into the appropriate collection container.

Finally, it is possible to provide a solution that does not require reinforcing elements such as primers and resin, but only the resin or the bio-resin.

As previously anticipated, the above description relates to specific and particularly preferred embodiments. However, various modifications may be made to the processing steps described above, without departing from the scope of the invention. Likewise, it can be assumed that solutions similar to those described for the realization of specific elements for making inserts for bones or teeth of living beings undergo modifications to satisfy similar purposes, according to the product type or to physical characteristics (tolerance, resistance, etc.).

For example, three needlefelting steps have been described. However, in some cases, with lower quality fibres, a smaller number of needlefelting steps may be sufficient.

Moreover, at the moment the entire description is based exclusively on the hypothesis of recovery and regeneration of non-woven fabrics; however, it is clear that this process can also be used in hybrid solutions, wherein the addition of layers of virgin non-woven fabric, or other material required for obtaining specific optical, mechanical or conduction properties, is envisaged during the drawing step.

Finally, the drawing and treatment step of the material is now carried out by needlefelting: it is not excluded that, in the future, different methods may be provided which may be preferable, and therefore replace it, without the inventive scope of the present invention being in any way limited or exceeded.

From the above description, it can thus be easily understood that the product thus obtained is to all effects a non-woven fabric useful as a structural reinforcement.

It is understood that the prefixed objectives have thus been obtained, i.e., a regenerated non-woven fabric having physical-chemical, visual and tactile properties has been produced which is similar to that created by an original extrusion, with a much lower cost compared to the costs of the current regeneration processes and suitable to associate various types of products during the processing step, to obtain composite fibres according to specific needs.

Furthermore, a particular type of item has been obtained with such physical properties as to allow the use in specific sectors of dentistry and medicine.

As anticipated above, the above description relates to specific embodiments of the realization process of a recycled carbon fibre non-woven fabric. However, various modifications may be made to the processing steps described above, without departing from the scope of the invention.

For example, three needlefelting steps have been described. However, in some cases, with lower quality fibres, a smaller number of needlefelting steps may be sufficient.

Moreover, at the moment, the entire description was based exclusively on the hypothesis of recovery and regeneration of carbon fibres; however, this process can also be used in hybrid solutions, wherein the addition of layers of virgin non-woven fabric, or other material required for obtaining specific optical, mechanical or conduction properties, is envisaged during the drawing step.

This process also allows the realization of non-woven fabrics composed of carbon fibres mixed in percentages according to the needs of the end user, with various synthetic and vegetable fibres, such as aramid fibre (Kevlar), PBO fibre, glass fibre, coir fibre, jute fibre.

Technically, the process can also be implemented for the production of non-woven fabrics composed of one or more of the aforementioned fibres other than carbon fibre, hence in the absence of carbon fibres.

Finally, the drawing and treatment step of the material is now carried out by needlefelting: it is not excluded that, in the future, different methods may be provided which may be preferable, and therefore replace it, without the inventive scope of the present invention being in any way limited or exceeded.

From the above description, it can thus be easily understood that the product thus obtained is to all effects a non-woven fabric useful as a structural reinforcement.

It is understood that the prefixed objects have thus been obtained, i.e., a regenerated non-woven fabric having physical-chemical, visual and tactile properties has been produced which is similar to that created by an original extrusion, with a much lower cost in respect to the costs of the current regeneration processes and suitable to associate various types of products during the processing, to obtain composite fibres according to needs.

It is therefore understood that the solutions and the various embodiments now described have only illustrative and non-limiting purposes with reference to the scope of the invention, which is defined by the appended claims.

What is claimed is:

1) Process for transforming synthetic and vegetable fibres into a non-woven fabric of the type which provides the following sequence of processing steps:
flock opening step, during which fibrous materials of different shapes and sizes are transformed into fibre flocks of different lengths comprising at least long-fibre flocks and short-fibre flocks;
drawing and treatment step of the material selected in the previous step;
cutting and trimming step: once the drawing and treatment step of the material has been completed, the non-woven fabric is subjected to longitudinal cutting and trimming, to make a series of rolls for final use;
characterized in that
after the flock opening step, flocks are transferred to a condenser, where the long-fibre flocks are separated from the short-fibre flocks, by means of a perforated mesh screen.

2) Process as in claim 1 characterized in that the long-fibre flocks derived from the opening of said non-woven fabric are subjected to a moistening process, said process being carried out by means of a nebulization system installed on machinery used in the first two processing steps.

3) Process as in claim 1 characterized in that the drawing of said separate flocks in said condenser further comprises the step of subsequent carding to form a homogeneous web.

4) Process as in claim 3 characterized in that said carding is carried out using at most six working rollers, suitable for creating a web with a thickness ranging between 0.1 mm and 0.5 mm.

5) Process as in claim 3, characterized in that a web laying step is further provided, with the overlap of various webs deriving from the carding by means of a belt-type web laying machine.

6) Process as in claim 5 characterized in that the long-fibre flocks derived from the opening of said non-woven fabric are subjected to a moistening process that takes place between the opening step and the web laying step.

7) Process as in claim 5 characterized in that, after the web laying step, a needlefelting step is further provided, carried out through needlefelting machines, provided with plates with needles suitable to engage with the web mass and to penetrate said mass to bind the fibres between one another.

8) Process as in claim 7 characterized in that three needlefelting machines are provided, arranged according to different geometries.

9) Process as in claim 8 characterized in that said three needlefelting machines operate respectively from the top to the bottom and again from the top.

10) Process as in claim 8 characterized in that said three needlefelting machines operate respectively from the bottom, from the top and from the bottom.

11) Process as in claim 7 characterized in that a first one of said needlefelting machines operates from the top and from the bottom simultaneously, a second one of said needlefelting machines operates from the top and from the bottom simultaneously, and finally a third one of said needlefelting machines operates from the top and from the bottom simultaneously.

12) Process according to claim 7, characterized in that a device for conveying and compacting the web mass is provided upstream of said needlefelting step, the device comprising a pair of converging conveyor belts or overlapping rollers that convey the web mass within a compaction area consisting of two series of parallel rollers arranged horizontally.

13) Process as in claim 12 characterized in that, following said needlefelting step, the non-woven fabric is coupled to a fabric made of a different material, through a processing carried out at high temperatures with calenders.

14) Process as in claim 1 characterized in that the transfer of the flocks to said condenser takes place by means of mechanical or pneumatic transport means.

15) Process as in claim 1, characterized in that said synthetic and vegetable fibres are carbon fibres.

16) Process as in claim 1, characterized in that a further realization step of a monolithic item with a defined geometrical shape consisting of a single layer of non-woven fabric with a predetermined weight is provided, said layer being subjected to pre-cutting by means of die-cutting machines of the non-woven fabric obtained from the previous steps and subsequent lamination.

17) Process according to claim 1, characterized in that a further coupling step is provided for pre-cut layers by means of die-cutting machines of the non-woven fabric obtained from the preceding steps and subsequent lamination.

18) Process according to claim 16 characterized in that said item has a shape selected among disc shape, square shape or rectangular shape.

19) Process according to claim 16 characterized in that, at the end of the lamination operations, the obtained item is treated with finishing primers or resins.

20) Process as in claim 17 characterized in that the following steps are further provided:
a resin impregnation step, said resin having weight percentages between 30% and 70%,
a step for the application of various longitudinal seams, parallel to each other along the entire length of the piece of non-woven fabric, said impregnation step taking place by inserting the pre-impregnated non-woven fabric into a hot mould, with a temperature ranging between a minimum of 30° C. and a maximum of 240° C., and by subsequent closing and pressing of the counter mould on the mould, and
a further milling step by means of three milling machines for each disc, two opposed ones and a single one, said pair of opposed milling machines making a 10-mm lateral groove and said second milling machine working only from above.

21) Item produced by the process according to claim 16 characterized in that said monolithic item is used as a base for dental prostheses or bone prostheses.
